(19) United States
(12) Patent Application Publication
(10) Pub. No.: US 2020/0128865 A1
(43) Pub. Date: Apr. 30, 2020

(54) Food substitutes

(71) Applicant: Mederer GmbH, Fuerth (DE)

(72) Inventor: Herbert MEDERER, Fuerth (DE)

(21) Appl. No.: 16/607,431

(22) PCT Filed: Apr. 24, 2018
(86) PCT No.: PCT/EP2018/060469

§ 371 Date: Oct. 23, 2019

(30) Foreign Application Priority Data
Apr. 25, 2017 (DE) 10 2017 206 960.0
May 11, 2017 (DE) 10 2017 208 016.7

(51) Int. Cl. A23L 33/125; A23L 29/281; A23L 33/15; A23L 33/16; A23L 33/21

(52) U.S. Cl. CPC A23L 33/125; A23L 29/284; A23V 2002/00; A23L 33/16; A23L 33/21; A23L 33/15

(57) ABSTRACT

A semi-solid food substitute is provided having a base composition including starch syrup, saccharides, and at least one gelling agent and having a protein content between 10% by weight and 30% by weight and a fat content between 5% by weight and 20% by weight.

### CROSS-REFERENCE TO RELATED APPLICATIONS

This application claims the priorities of German Patent Applications, Serial No. DE 10 2017 206 960.0, filed on Apr. 25, 2017, and DE 10 2017 208 016.7, filed on May 11, 2017, pursuant to 35 U.S.C. 119(a)-(d), the contents of which are incorporated herein by reference in its entirety as if fully set forth herein.

### FIELD OF THE INVENTION

The invention relates to a semi-solid food substitute. In addition, the invention is directed to a process for the production of such food substitutes.

### BACKGROUND OF THE INVENTION

Food substitutes and their production are widely known and are of proven utility. Food substitutes generally serve a particular nutritional purpose.

### SUMMARY OF THE INVENTION

An object underlying the invention is to provide a food substitute that is able to prevent malnutrition with particular reliability and have exceptionally good ingestability by a person/patient. An additional aim is to establish a particularly economical and gentle process for producing such food substitutes.

This object is achieved according to the invention by a semi-solid food substitute, having a base composition comprising starch syrup, in particular glucose syrup, saccharides, in particular monosaccharides and disaccharides, in particular sucrose/sugar, and at least one gelling agent, having a protein content between 10% by weight and 30% by weight, and having a fat content between 5% by weight and 20% by weight.

This object is further achieved according to the invention by a process for producing a semi-solid food substitute according to the features of the inventive semi-solid food substitute, comprising the steps: providing a base composition, comprising starch syrup, in particular glucose syrup, saccharides, in particular monosaccharides and disaccharides, in particular sucrose/sugar, and at least one gelling agent, wherein the semi-solid food substitute has a protein content between 10% by weight and 30% by weight, and a fat content between 5% by weight and 20% by weight.

The essence of the invention is that the food substitute is semi-solid and contains both protein and fat/oil. The consistency of the food substitute is preferably gelatinous or jelly-like. This makes it easy to swallow the food substitute. Chewing the food substitute promotes salivary flow. The stated composition has been found to be particularly advantageous for persons/patients. The stated compositions of the food substitute relate in particular to the total weight of the finished food substitute.

The food substitute is intended primarily for the dietary treatment of persons/patients with disease-related malnutrition/undernutrition, for example on account of an inadequate intake of food or else an inadequate supply of energy. It can also be used in age-related or disease-related malnutrition, for example in tumor cachexia. Likewise, it may be used in general malnutrition in the population, for example in crisis areas. For example, it is also used when energy requirements are increased, during convalescence, and in pre- and postoperative nutrition. The food substitute is intended primarily as supplementary nutrition. It may be used, for example, when weight loss needs to be slowed or arrested quickly and healthily. The food substitute conveniently has a high calorie content. It conveniently contains all nutrients that would otherwise be ingested through normal foods. In particular, it facilitates coverage of the daily nutrient requirement.

It is advantageous if the food substitute is bite-sized. In its longest dimension, for example, it is smaller than 5 cm, more preferably 2 cm. It is, for example, single-layered or multilayered. It may have at least one filling. Alternatively, it has no filling

The food substitute preferably takes the form of a shaped body. It is preferably deformable or yielding. It has, for example, a tough consistency between that of a solid and a liquid. This is the case, for example, at ambient temperature, for example 20° C.

It is advantageous if the base composition is/includes a fruit gum mass. The food substitute is preferably based on fruit gum. In particular, the at least one gelling agent results in gelation. The at least one gelling agent conveniently comprises gelatin.

The starch syrup contained in the base composition is conveniently a thickened solution obtained from starch. It is advantageous if the starch syrup comprises glucose and, conveniently, fructose too. The starch syrup is, for example, glucose syrup, glucose-fructose syrup or fructose-glucose syrup.

The food substitute or starch syrup contains saccharides, such as mono-, di- or polysaccharides.

It is expedient if the protein used is collagen peptide, whey protein, milk protein and/or pea protein. It is advantageous if individual, in particular essential, amino acids are additionally added. A balanced amino acid combination is conveniently used. A gelatin-protein solution is preferably used.

It is advantageous if the protein content of the food substitute is achieved through a customized protein profile Amino acids used preferably cover the needs of the individual and preferably meet the requirements of the German Nutrition Society.

It is expedient if MCT fats (medium-chain triglycerides) that contain medium-chain fatty acids are used as fats in the food substitute.

It is advantageous if the food substitute contains secondary plant substances, such as phenolic compounds, isoprenoid compounds, and/or alkaloids.

The production process is conveniently suitable for mass production of the food substitutes.

The food substitute comprising a carbohydrate content between 30% by weight and 60% by weight, is a true energy source and provides the person/patient ingesting the food substitute with energy, in particular for the brain and muscles. The carbohydrates are conveniently able to maintain constant blood glucose levels in the person/patient ingesting the food substitute. It is advantageous if the carbohydrates are a constituent of the base composition.

According to the invention, the food substitute contains sugar, in particular between 5% by weight and 20% by weight of sugar/sucrose. The sugar is a constituent of the base composition. When ingesting the food substitute, the sugar preferably provides energy quickly. It also reduces nervousness in the person/patient ingesting the food substitute and helps ensure particularly high capability in such persons/patients.

The protein according to the inventive food substitute is preferably a constituent of the base composition

The gelatin according to the inventive food substitute preferably contains up to 90% by weight of protein. Alternatively or additionally, a gelling agent based on polysaccharides, in particular based on plant polysaccharides, such as pectins and starch, is used.

The at least one vitamin according to the inventive food substitute strengthens, for example, the immune system of the person/patient ingesting the food substitute and/or helps build cells, blood cells, bones and/or teeth. When ingested, it conveniently regulates the utilization of carbohydrates, proteins and/or minerals. The vitamin may be, for example, choline chloride, vitamin C, ascorbyl palmitate, nicotinamide, mixed tocopherols, calcium pantothenate, vitamin E, vitamin B6, vitamin B1, vitamin B2, vitamin A palmitate, folic acid, β-carotene, biotin, vitamin K1, vitamin D3, and/or vitamin B12. It is preferable if a vitamin solution is used.

The at least one mineral according to the inventive food substitute is an essential inorganic nutrient. This forms, in particular, the basis for the survival of living cells. For example, the mineral used may be potassium phosphate, potassium chloride, potassium iodide, calcium carbonate, magnesium carbonate, magnesium chloride, sodium chloride, sodium citrate, tricalcium phosphate, zinc sulfate, sodium phosphate, iron phosphate, iron sulfate, manganese sulfate, copper sulfate, chromium chloride, sodium molybdate, and/or sodium selenate.

The at least one trace element according to the inventive food substitute prevents deficiency diseases or deficiency symptoms in particular. They are preferably organic constituents that are needed in particular for building bones, teeth, hormones, and blood cells. Examples of trace elements used are manganese, molybdenum, and/or chromium.

The dietary fibers according to the inventive food substitute are particularly important for a healthy diet. They have a particularly beneficial effect on digestion in the body of the person/patient. They have a convenient ability to bind water. They also have a particularly beneficial effect on the intestinal flora of the person/patient ingesting the food substitute as well as reducing the risk of myocardial infarction and diabetes. The dietary fibers preferably support the immune system. They are preferably prebiotic. The dietary fibers are preferably derived from oligosaccharides and/or inulin.

According to the invention, the food substitute is based on fruit gum. At room temperature, for example at 20° C., it conveniently has an elastic, rubbery texture and consistency. It is expedient if the food substitute includes viscous components, which preferably then give the food substitute a flexible gel structure. It is preferable if the food substitute is nevertheless firm. It is advantageous if it is relatively easily deformable and/or dividable.

The oil and/or fat according to the invention are conveniently stirred into the base composition, which is then preferably heated.

The at least one mineral substance according to the invention is conveniently stirred into the base composition, which is then preferably heated.

The at least one vitamin according to the invention is conveniently stirred into the base composition, which is then preferably heated. It is preferably added as a vitamin solution.

It is preferable if a stevia solution and/or emulsifier is also added to the base composition.

According to the invention, the process includes at least one casting step for forming the semi-solid food substitutes.

The inventive process for producing a semi-solid food substitute comprises foaming a food-substitute mass comprising the base composition to form a foam-like food-substitute mass in at least one foaming device using protective gas, wherein the protective gas is conveniently natural, odorless, and tasteless. It is advantageous if the protective gas is nitrogen and/or carbon dioxide. In particular, the protective gas displaces the air present, in particular its oxygen. In particular, the protective gas is used instead of oxygen for foaming the food-substitute mass. Such a process results in food substitutes that have a particularly long shelf life.

The process, wherein the food substitute is packaged in a packaging station having a protective-gas unit to package the food substitute under a protective gas atmosphere, also results in a food substitute that has an exceptionally long shelf life. The protective gas is conveniently natural, odorless, and tasteless. It is preferably nitrogen and/or carbon dioxide. In particular, the protective gas displaces the air, in particular its oxygen, from the packaging containing the at least one food substitute. The packaging is preferably of the bag type. It is advantageous if the packaging is formed from at least one film.

It is advantageous if the food substitute contains omega-3 fatty acids. Formulation without omega-3 fatty acids is alternatively possible. It preferably contains coloring agent and/or flavoring.

The terms “upstream” and “downstream” or similar employed here refer in particular also to the conveyed constituent or mass.

A preferred embodiment of the invention is described below by way of example, with reference to the accompanying drawing.

### BRIEF DESCRIPTION OF THE DRAWING

FIGS. 1, 2 show a production line for producing a food substitute according to the invention, and

FIG. 3 shows a flow diagram illustrating the production of the food substitutes according to the invention.

### DESCRIPTION OF THE PREFERRED EMBODIMENT

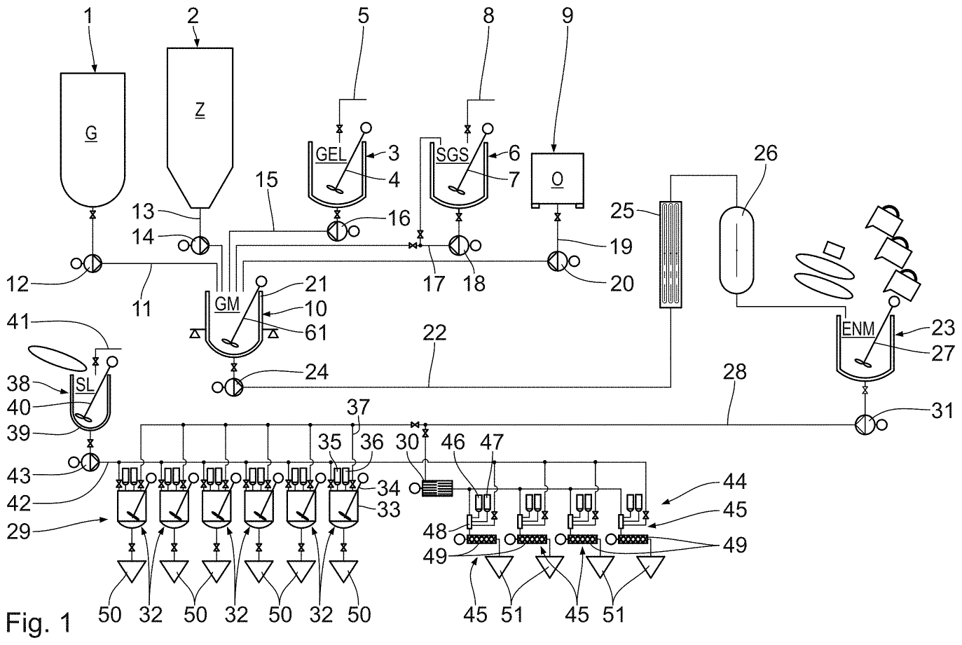

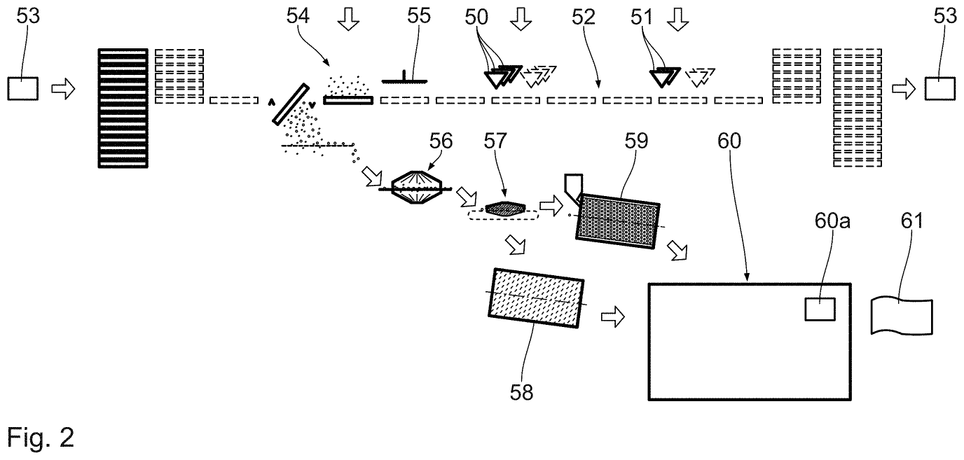

With reference first to FIGS. 1, 2, a production line for producing semi-solid food substitutes, which is shown in its entirety, includes a glucose-syrup reservoir 1 for holding glucose syrup G.

The production line additionally includes a sugar reservoir 2 for holding sugar Z.

In addition, the production line has a protein-dissolution vessel 3 fitted with a motor-driven stirrer unit 4. The protein-dissolution vessel 3 is used for the production of a gelatin-protein solution GEL from powdered gelatin hydrolyzate, powdered milk protein, powdered pea protein, powdered gelatin as gelling agent, and also amino acids. Water can be fed into the protein-dissolution vessel 3 in a controlled manner through a water line 5.

The production line also includes a starch-galactose-suspension vessel 6 having a motor-driven stirrer unit 7. The starch-galactose-suspension vessel 6 is used for the production of a starch-galactose suspension SGS from galactose and starch. Water can be fed into the starch-galactose-suspension vessel 6 in a controlled manner through a water line 8.

The production line also includes an oligofructose reservoir 9 for holding oligofructose O. An embodiment without an oligofructose reservoir 9 or oligofructose O is alternatively possible.

A component balance/metering balance 10 is situated downstream of vessels 1, 2, 3, 6, and 9.

A glucose-syrup feed line 11 leads from the glucose-syrup reservoir 1 to the component balance 10. The glucose-syrup feed line 11 is fitted with a motor-driven glucose-syrup feed pump 12 for conveying the glucose syrup G from the glucose-syrup reservoir 1 to the component balance 10.

A sugar feed line 13 leads from the sugar reservoir 2 to the component balance 10. The sugar feed line 13 is fitted with a motor-driven sugar screw conveyor 14 for conveying the sugar Z from the sugar reservoir 2 to the component balance 10.

A protein solution feed line 15 leads from the protein-dissolution vessel 3 to the component balance 10. The protein solution feed line 15 is fitted with a motor-driven protein solution feed pump 16 for conveying the gelatin-protein solution GEL from the protein-dissolution vessel 3 to the component balance 10.

A starch-galactose-suspension feed line 17 leads from the starch-galactose-suspension vessel 6 to the component balance 10. The starch-galactose-suspension feed line 17 is fitted with a motor-driven starch-galactose-suspension feed pump 18 for conveying the starch-galactose suspension SGS from the starch-galactose-suspension vessel 6 to the component balance 10.

An oligofructose feed line 19 leads from the oligofructose reservoir 9, if present, to the component balance 10. The oligofructose feed line 19 is fitted with a motor-driven oligofructose feed pump 20 for conveying oligofructose O from the oligofructose reservoir 9 to the component balance 10.

It is advantageous if at least one actuatable metering valve is fitted in each feed line 11, 13, 15, 17, 19 upstream and/or downstream of the respective feed pump/screw conveyor 12, 14, 16, 18, 20.

The component balance 10 includes a motor-driven stirrer unit 61. In a mixing vessel 21 which is part of the component balance 10, the constituents added, namely the glucose syrup G, the sugar Z, the gelatin-protein solution GEL, the starch-galactose suspension SGS, and the oligofructose O, if present, can be mixed by the stirrer unit 61 to form a base composition GM.

A base composition feed line 22 leads from the component balance 10 to an addition vessel 23. The base-composition feed line 22 is fitted with a motor-driven base-composition feed pump 24 for conveying the base composition GM from the component balance 10 to the addition vessel 23.

The base-composition feed line 22 is also fitted, downstream of the base-composition feed pump 24, with a base-composition boiler unit 25 and a base-composition vacuum unit 26. The base-composition boiler unit 25 is able to continuously boil the base composition GM. In the base-composition vacuum unit 26, the boiled base composition GM that is fed in can be subjected to vacuum to reduce its moisture content and temperature.

The addition vessel 23 can be charged with the base composition GM, fat, emulsifiers, minerals, a vitamin solution, and also stevia solution. These are mixed together there by a stirrer unit 27 to form a castable food-substitute mass ENM.

From the addition vessel 23, a distribution line 28 leads to a gum-metering apparatus 29 and to a foaming machine 30, which are connected in parallel. The distribution line 28 is fitted with a food-substitute-mass feed pump 31 for conveying the food-substitute mass ENM to the gum-metering apparatus 29 and to the foaming machine 30.

The gum-metering apparatus 29 comprises a plurality of gum-metering devices 32, which are of identical construction and connected in parallel. Each gum-metering device 32 is used to form a gum-like food-substitute mass gENM from the food-substitute mass ENM. Each comprises a metering vessel 33 fitted with a motor-driven stirrer unit 34. Each metering vessel 33 is associated with a flavoring feed unit 35 and a coloring-agent feed unit 36 of the gum-metering device 32. Each metering vessel 33 is in flow connection, via a branch line 37, with the distribution line 28.

The apparatus also comprises an acid-dissolution unit 38 with an acid vessel 39 fitted with a motor-driven stirrer unit 40. The acid vessel 39 can be charged with acid. The acid-dissolution unit 38 is used to form an acid solution SL. The acid vessel 39 can be fed with water via a water line 41.

Leading from the acid vessel 39 is an acid feed line 42, which is fitted with a motor-driven acid feed pump 43 for conveying the acid solution SL. The acid feed line 42 is in flow connection with each metering vessel 33.

Fitted downstream of the foaming machine 30 is a foam-metering apparatus 44 having a multiplicity of foam-metering devices 45, which are of identical construction and connected in parallel. Each foam-metering device 45 is used to form a foam-like food-substitute mass sENM from the food-substitute mass ENM. Each comprises a flavoring feed unit 46 and a coloring-agent feed unit 47. Each foam-metering device 45 also has a metering pump 48, which is in flow connection with the foaming machine 30. In addition, each flavoring feed unit 46 and coloring-agent feed unit 47 of a foam-metering device 45 and the acid-dissolution unit 38 are in flow communication with a corresponding metering pump 48.

Downstream of each metering pump 48, each foam-metering device 45 has a motor-driven dynamic mixer 49.

Situated downstream of each gum-metering device 32 is a first mogul casting machine 50 of the production line. Situated downstream of each foam-metering device 45 is a second mogul casting machine 51 of the production line. In the casting machines, the gum-like and foam-like food-substitute masses gENM and sENM are cast in native corn starch.

Downstream of the first mogul casting machine 50 and the second mogul casting machine 51, the production line is equipped with conveyors 52 for transporting the cast food-substitute masses gENM and sENM to a drying room 53 of the production line. The drying room 53 is at a temperature of about 23° C., with a relative humidity of 35%.

In a powder mogul casting machine 54 of the production line, the dried food-substitute masses gENM and sENM are molded and depowdered to form food substitutes or food substitute bodies/items. The powder mogul casting machine 54 uses a box that is filled with starch. At least one mold stamp 55 is used to stamp a desired shape for the food substitute item into molding powder or starch.

The shaped food substitutes undergo cleaning in a cleaning unit 56 situated downstream of this in the production line.

Downstream of the cleaning unit 56, a steam-treatment unit 57 is fitted for steam-treatment of the cleaned food substitutes.

Downstream of the steam-treatment unit 57 are an oil drum 58 and a sugar drum 59, which are connected in parallel and are used for the surface treatment of the steam-treated food substitutes.

This is followed by the packaging of the surface-treated finished food substitutes in a packaging station 60.

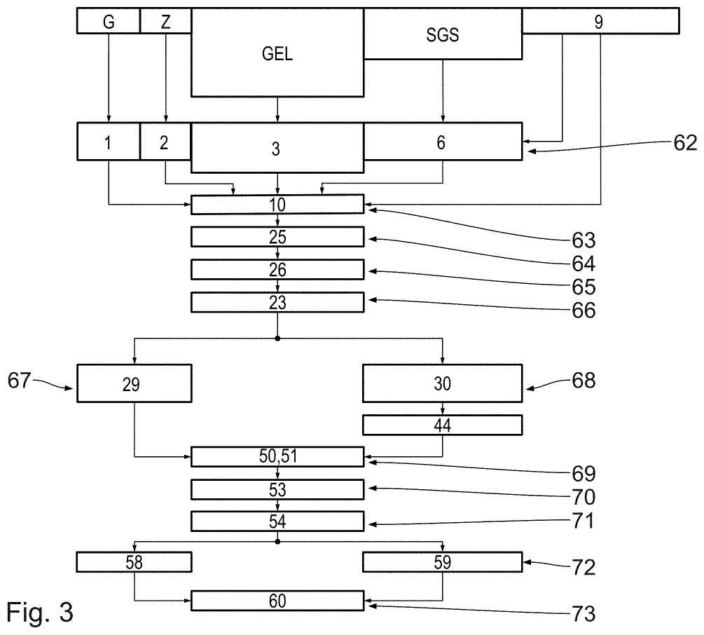

The production process is explained again below with reference to FIG. 3. As mentioned previously, glucose syrup G is held in the glucose-syrup reservoir 1, whereas sugar Z is held in the sugar reservoir 2.

Held in the protein-dissolution vessel 3 are gelatin hydrolyzate, milk protein, pea protein and gelatin as gelling agents and also amino acids. Water is added. Mixing by the stirrer unit 4 to form the gelatin-protein solution GEL then takes place there.

Held in the starch-galactose-suspension vessel 6 are galactose and starch. Water is added. They are then mixed with one another by the stirrer unit 7 to form the starch-galactose suspension SGS.

The glucose syrup G, the sugar Z, the gelatin-protein solution GEL, the starch galactose suspension SGS, and the oligofructose O, if present, from the oligofructose reservoir 9 are then fed to the component balance 10 in a subsequent step 62 and mixed in the mixing vessel thereof by the stirrer unit 61.

After this, the resulting base composition GM is boiled in a subsequent step 63 in the continuously-operated base-composition boiler unit 25 and then subjected to vacuum in the base-composition vacuum unit 26 in a subsequent step 64.

The boiled and vacuum-treated base composition GM is then fed into the addition vessel 23 in a subsequent step 65. Fat, emulsifiers, minerals, a stevia solution and a vitamin solution are additionally fed into the addition vessel 23, where they are mixed with one another by a stirrer unit 27 to form the food-substitute mass ENM.

In a subsequent step 66, the resulting food-substitute mass ENM is then fed either into the gum-metering apparatus 29 or into the foaming machine 30.

In a subsequent step 67, the food-substitute mass ENM, flavoring from the flavoring feed unit 35, coloring agent from the coloring-agent feed unit 36, and the acid solution SL are fed into each metering vessel 33, where they are mixed together by the respective stirrer unit 34 to form the gum-like food-substitute mass gENM.

In a subsequent step 68, each metering pump 48 is fed with the food-substitute mass ENM foamed by the foaming machine 30, flavoring from the flavoring feed unit 46, coloring agent from the coloring-agent feed unit 47, and the acid solution SL. Foam-like food-substitute masses sENM are produced in the dynamic mixers 49.

After this, in a subsequent step 69, the resulting gum-like food-substitute mass gENM is fed into the first mogul casting machine 50, whereas the resulting foam-like food-substitute mass sENM is fed into the second mogul casting machine 51.

In a subsequent step 70, the cast masses are then dried in the drying room 53 for 48 hours to reduce their moisture content.

After this, in a subsequent step 71, cast food substitutes formed from the dried masses are created in the powder mogul casting machine 54, which are either gum-like or foam-like.

The food substitutes undergo cleaning in the cleaning unit 56. The cleaned food substitutes then undergo stream-treatment in the steam-treatment unit 57.

This is followed by surface treatment in a subsequent step 72. In the sugar drum 59, the food substitutes are treated with sugar. In the oil drum 58, the food substitutes are alternatively oiled.

In the foaming machine 30, the food-substitute mass ENM undergoes foaming/expansion using protective gas, in particular nitrogen.

This is followed by packaging of the sugared or oiled food substitutes in the packaging station 60 in a subsequent step 73. The food substitutes are packaged in the packaging station 60 into packaging bags 61. The packaging station 60 provides the packaging bags 61 with a protective gas atmosphere, in particular a nitrogen atmosphere, by means of a protective gas source 60a.

The protein content of the finished food substitute is preferably between 15% and 25% by weight. The fat content is preferably between 10% and 15% by weight. The carbohydrate content is preferably between 35% and 55% by weight.

The finished semi-solid food substitute preferably comprises glucose syrup, proteins (collagen peptides, milk protein, whey protein, pea protein, amino acids (such as isoleucines, leucines, tryptophans)), palm oil, palm fat, coconut oil, sunflower oil, sugar, galactose, gelatin, pea starch, acidifier (lactic acid, citric acid), minerals (potassium phosphate, calcium carbonate, magnesium carbonate, sodium chloride, zinc sulfate, sodium phosphate, iron phosphate, manganese sulfate, copper sulfate, chromium chloride, sodium molybdate, sodium selenate), oligofructose, inulin, emulsifier (mono- and diglycerides of edible fatty acids), flavoring, coloring foodstuffs (blackcurrant, black carrot, sweet potato, radish, apple, turmeric, safflower, spirulina, caramel sugar syrup), coating (beeswax (white, yellow), carnauba wax) and vitamins (choline chloride, vitamin C, ascorbyl palmitate, nicotinamide, mixed tocopherols, calcium pantothenate, vitamin E, vitamin B6, vitamin B1, vitamin B2, vitamin A palmitate, folic acid, β-carotene, biotin, vitamin K1, vitamin D3, vitamin B12), water. Individual constituents may be omitted.

Alternatively, the food substitute or its base composition is free of starch syrup and/or saccharides. A food substitute without saccharides is, in particular, sugar-free. It then preferably includes other sweeteners/or sweetening agents. Such a food substitute or a corresponding process for producing such a food substitute may form a separate subject of the invention.

1-17. (canceled)

18. A semi-solid food substitute,
a) having a base composition comprising
i) starch syrup,
ii) saccharides, and
iii) at least one gelling agent,
b) having a protein content between 10% by weight and 30% by weight, and
c) having a fat content between 5% by weight and 20% by weight.

19. A semi-solid food substitute as claimed in claim 1 having a base composition comprising glycose syrup.

20. The food substitute as claimed in claim 18, comprising a carbohydrate content between 30% by weight and 60% by weight.

21. The food substitute as claimed in claim 18, comprising sugar, wherein the food substitute contains between 5% by weight and 20% by weight of sugar.

22. The food substitute as claimed in claim 18, comprising protein.

23. The food substitute as claimed in claim 18, wherein the at least one gelling agent is gelatin.

24. The food substitute as claimed in claim 23, wherein the at least one gelling agent includes gelatin.

25. The food substitute as claimed in claim 18, comprising at least one vitamin.

26. The food substitute as claimed in claim 18, comprising at least one mineral.

27. The food substitute as claimed in claim 18, comprising at least one trace element.

28. The food substitute as claimed in claim 18, comprising dietary fibers.

29. The food substitute as claimed in claim 18, wherein the food substitute is based on fruit gum.

30. A process for producing a semi-solid food substitute according to the invention, comprising the steps:
providing a base composition, comprising
starch syrup,
saccharides, and
at least one gelling agent,
wherein the semi-solid food substitute has
a protein content between 10% by weight and 30% by weight, and
a fat content between 5% by weight and 20% by weight.

31. A process for producing a semi-solid food substitute as claimed in claim 13, wherein the base composition comprises glycose syrup.

32. The process as claimed in claim 30, comprising adding at least one of the group comprising oil and fat to the base composition.

33. The process as claimed in claim 32, comprising adding at least one of the group comprising oil and fat to the heated base composition.

34. The process as claimed in claim 30, comprising adding at least one mineral to the base composition.

35. The process as claimed in claim 34, comprising adding at least one mineral to the heated base composition.

36. The process as claimed in claim 30, comprising adding at least one vitamin to the base composition.

37. The process as claimed in claim 36, comprising adding at least one vitamin to the heated base composition.

38. The process as claimed in claim 30, comprising at least one casting step for forming the semi-solid food substitutes.

39. The process as claimed in claim 30, comprising foaming a food-substitute mass comprising the base composition to form a foam-like food-substitute mass in at least one foaming device using protective gas.

40. The process as claimed in claim 30, wherein the food substitute is packaged in a packaging station having a protective-gas unit to package the food substitute under a protective gas atmosphere.
